(19) United States
(12) Patent Application Publication
(10) Pub. No.: US 2018/0299609 A1
(43) Pub. Date: Oct. 18, 2018

(54) METHOD FOR MANUFACTURING BACKLIGHT MODULE

(71) Applicants: HKC CORPORATION LIMITED, Shenzhen City, Guangdong (CN); CHONGQING HKC OPTOELECTRONICS TECHNOLOGY CO., LIMITED, Chongqing (CN)

(72) Inventor: Chia-Hang LEE, Chongqing (CN)

(21) Appl. No.: 15/580,149

(22) PCT Filed: Aug. 15, 2017
(86) PCT No.: PCT/CN2017/097481

§ 371 Date: Dec. 6, 2017

(30) Foreign Application Priority Data
Dec. 31, 2016 (CN) 201611268468.4

(51) Int. Cl. F21V 8/00; G02F 1/1335

(52) U.S. Cl. CPC G02B 6/0036; G02F 1/133615; B82Y 20/00; G02F 2001/133614; G02B 6/0058

(57) ABSTRACT

This application relates to a method for manufacturing a backlight module. The manufacturing method includes: providing a light guide plate, including a bottom surface and a plurality of screen dot recessed parts arranged in a two-dimensional manner, where the screen dot recessed parts are located on the bottom surface; filling a quantum dot material into each of the screen dot recessed parts; disposing a substrate on the bottom surface of the light guide plate, and sealing the quantum dot material in the screen dot recessed part of the light guide plate by using the substrate; and disposing a light source at one side of the light guide plate.

### BACKGROUND

### Technical Field

This application relates to a method for manufacturing a backlight module, and in particular, to a method for manufacturing a backlight module capable of sealing a quantum dot material in a light guide plate.

### Related Art

In recent years, with the development of science and technologies, various display devices, for example, liquid crystal displays (LCD) or electroluminescence (EL) display devices have been widely applied to flat panel displays. The LCD is used as an example. Most LCDs are backlight LCDs including an LCD panel and a backlight module. The LCD panel includes two transparent substrates and liquid crystals sealed between the substrates.

A quantum dot is a nano crystal whose diameter is equal to or less than 10 nanometers (nm), is made of a semiconductor material, and causes a quantum confinement effect. Compared with typical phosphor, the quantum dot generates denser light in a relatively narrow band. When electrons in an excited state are transmitted from a conduction band to a valence band, the quantum dot emits light, and has a feature that the optical wavelength changes according to a particle size even if the quantum dot is made of a same material. Because the optical wavelength changes according to the size of the quantum dot, light of an area having a required wavelength may be obtained by controlling the size of the quantum dot.

A quantum dot enhancement film (QDEF) is an optical component currently used in a backlight module, and is used for presenting colors of a display more precisely. The principle of the QDEF is: Two types of quantum dots in a large quantity are disposed on a film; blue light is used as a backlight source; when the blue light is illuminated to the two types of quantum dots, the blue light is separately converted to red light and green light; the generated red light and green light are mixed into white light together with the blue light; an effect of the mixed color is closer to an actual color by changing a ratio of converting the blue light into the red light and the green light, so that color presentation of the display is more precise. Therefore, how to use a quantum dot material to achieve a design manner of high efficiency and high productivity is currently one of the important topics.

### SUMMARY

To resolve the foregoing technical problem, an objective of this application is to provide a method for manufacturing a backlight module sealing a quantum dot material in a light guide plate.

The objective of this application is achieved and the technical problem of this application is resolved by using the following technical solutions. A method for manufacturing a backlight module provided according to this application comprises:

providing a light guide plate, comprising a bottom surface and a plurality of screen dot recessed parts arranged in a two-dimensional manner, where the screen dot recessed parts are located on the bottom surface;
filling a quantum dot material into each of the screen dot recessed parts;
disposing a substrate on the bottom surface of the light guide plate, and sealing the quantum dot material in the screen dot recessed part of the light guide plate by using the substrate; and

disposing a light source at one side of the light guide plate.

In some embodiments, when disposing the substrate on the bottom surface of the light guide plate, the substrate and the light guide plate may be engaged as an integral by using a laser.

In some embodiments, an optical film is disposed on the light guide plate.

In some embodiments, the light guide plate has a mixture of the quantum dot material and a printing solvent.

In some embodiments, the quantum dot material is an II-V group quantum dot material.

In some embodiments, the quantum dot material is an II-VI group quantum dot material.

In some embodiments, a material of the printing solvent is ink.

In some embodiments, the substrate comprises a reflective surface to reflect light.

In some embodiments, a refractive index coefficient of the substrate is less than or equal to a refractive index coefficient of the light guide plate, so as to form total reflection and reflect light.

In some embodiments, light excited by the light source has a wavelength in a range of 435 nanometers to 470 nanometers.

In some embodiments, the screen dot recessed parts are disposed in a density decreasing in a direction towards the light source and the screen dot recessed parts are disposed in a density increasing in a direction away from the light source, so that backlight provided by the backlight module may be more even.

In some embodiments, the quantum dot material has a yellow quantum dot material and a green quantum dot material.

In some embodiments, each of the screen dot recessed parts further comprises a separation glue, used for sealing the quantum dot material to avoid water vapor.

Another objective of this application is to provide a method for manufacturing a backlight module, comprising:

providing a light guide plate, comprising a bottom surface and a plurality of screen dot recessed parts arranged in a two-dimensional manner, where the screen dot recessed parts are located on the bottom surface;

filling a quantum dot material into each of the screen dot recessed parts, where the quantum dot material has a yellow quantum dot material and a green quantum dot material;

disposing a substrate on the bottom surface of the light guide plate, and sealing the quantum dot material in the screen dot recessed part of the light guide plate by using the substrate, wherein when disposing the substrate on the bottom surface of the light guide plate, the substrate and the light guide plate are engaged as an integral by using a laser, and a refractive index coefficient of the substrate is less than or equal to a refractive index coefficient of the light guide plate; and

disposing a light source at one side of the light guide plate, where light excited by the light source has a wavelength in a range of 435 nanometers to 470 nanometers; where

the screen dot recessed parts are disposed in a density decreasing in a direction towards the light source and the screen dot recessed parts are disposed in a density increasing in a direction away from the light source; and

each of the screen dot recessed parts further comprises a separation glue, used for sealing the quantum dot material.

An beneficial effect of this application is to provide a method for manufacturing a backlight module, so as to seal the quantum dot material on the light guide plate, thereby implementing a quantum dot (QD) backlight module and a display apparatus.

### BRIEF DESCRIPTION OF THE DRAWINGS

FIG. 1a is a display diagram of a light intensity of a band emitting light of an exemplary quantum dot;

FIG. 1b is a schematic diagram of an exemplary quantum dot tube;

FIG. 1c is a schematic diagram of an exemplary quantum film;

FIG. 2 is a schematic diagram of an optical design of a light guide plate using a quantum dot material according to an embodiment of this application;

FIG. 3 is a spectrum display diagram of a white light source having red, green, and blue light with high color saturation and converted through excitation of a blue-light light source according to an embodiment of this application;

FIG. 4 is a schematic diagram of a design manner of printed screen dots according to an embodiment of this application;

FIG. 5 is an architectural diagram of a display having a light guide plate according to an embodiment of this application;

FIG. 6 is a schematic diagram of a light guide plate according to an embodiment of this application; and

FIG. 7 is a schematic diagram of a light guide plate having a quantum dot material according to an embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical measures taken in this application to achieve the intended application objective and effects thereof, specific implementations, structures, features, and effects of a backlight module and a display device to which the backlight module is applied provided according to this application are described below in detail with reference to the drawings and preferred embodiments.

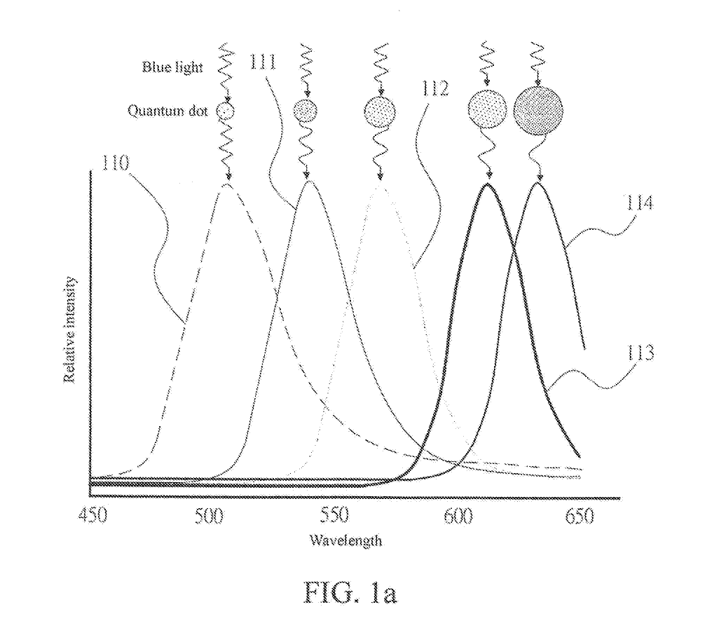

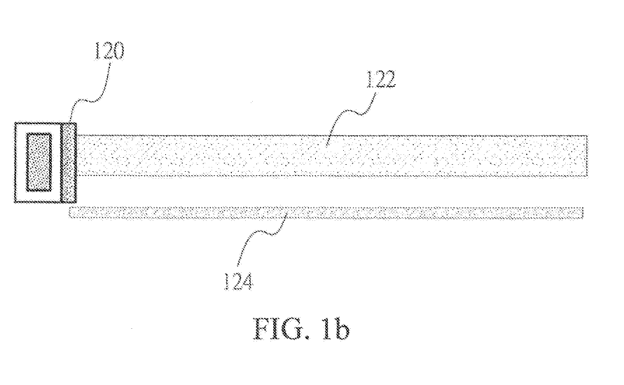

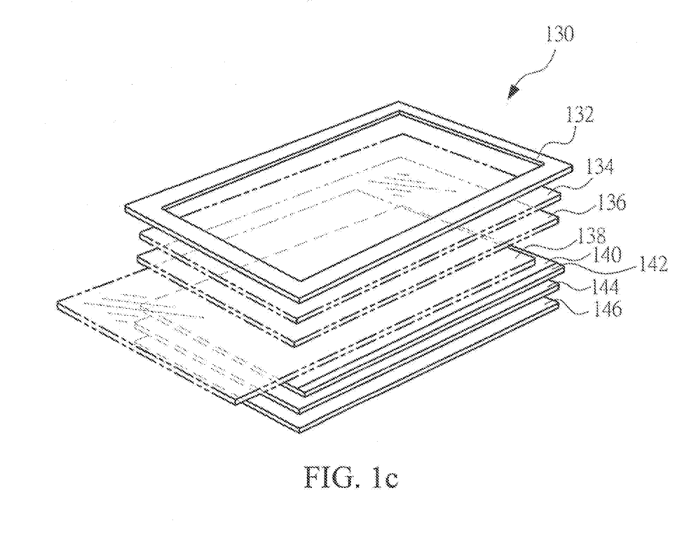

FIG. 1a is a display diagram of a light intensity of a band emitting light of a known quantum dot, FIG. 1b is a diagram of an exemplary quantum dot tube, and FIG. 1c is a diagram of an exemplary quantum film. Referring to FIG. 1a, to meet a higher requirement of human eyes on display colors, a wide color gamut is one of projects needing to be developed urgently in current display technologies. A quantum dot (referred to as QD below) display is a display manner of expanding a display color gamut. A display uses a QD light emitting material technology, the display usually has a feature of a relatively narrow light emitting wavelength (such as wavelengths of 110, 111, 112, 113, and 114 in FIG. 1a).

Referring to FIG. 1b and FIG. 1c, currently, methods for meeting a requirement on a wide color gamut display by using a QD technology are generally classified into the following two technologies. The first technology is a QD tube technology. That is, a QD material is encapsulated in a glass lamp 122, then a blue-light light-emitting diode 120 is used as a light source (as shown in FIG. 1b) exciting the QD material, and after blue light excites the QD material, an electrical dot generates light of red and green spectra, to obtain white light having spectra of three colors of red, green, and blue. The other QD technology is referred to as a QD film technology. The QD film technology, as the name implies, encapsulates a QD material in a film material as a sandwich structure. Upper and lower portions of the structure are protection films, and the QD material (as shown in FIG. 1c) is placed in the middle of the structure. When light emitted by the blue-light light-emitting diode is injected into the QD film, the QD material in the QD film is excited to emit red and green spectra, so as to generate a white-light light source.

Referring to FIG. 1c, FIG. 1c shows an existing backlight module 130, including a backplane 146, a baffle plate 132 connected to the backplane 146 and encircling an accommodation space together with the backplane 146, a light guide plate 140 disposed in the accommodation space, a QD enhancement film 138 disposed on a surface of the light guide plate 140 and located in the accommodation space, a light-emitting diode blue light source 142 disposed in the accommodation space, a reflector 144 disposed on a bottom surface of the light guide plate 140, and a plurality of optical films 134 and 136 stacked on the light guide plate 140. Light emitted by the light source of the backlight module 130 is transmitted by the light guide plate 140. By means of a reflection action of the optical films 134 and 136, when the light penetrates the QD enhancement film 138 from the light guide plate 140, the light may possibly be reflected to penetrate the QD enhancement film 138 again. The light penetrates the QD enhancement film 138 after being refracted for many times, generates compensation light after a light mixing action, and then penetrates the optical films 134 and 136. In addition, when the light penetrates the light guide plate 140 and is reflected by the reflector 144, the light returns into the light guide plate 140, and penetrates the QD enhancement film 138 after being refracted again to generate the compensation light.

Both design manners of the QD display described above have disadvantages. To avoid a problem that a QD material is invalid in a water vapor environment, the QD tube technology is generally used as a backlight source of a display. However, as described above, light of the QD tube needs to be converted twice (from the light-emitting diode to a QD tube surface, and from the QD tube surface to the light guide plate). Therefore, the QD tube has a poor effect in light conversion efficiency. Moreover, because there is one more tube on the appearance, the QD tube cannot be designed with a narrow frame in structure, and is difficult to be universally promoted in the current market. In another aspect, if the design manner of the QD film is used, because a film encapsulation manner is used, water vapor cannot be isolated completely and effectively. Therefore, on a periphery of the QD film, although there is a glue isolating the water vapor, a problem of an invalid area (that is, in the invalid area, the QD material cannot be excited) still exists. Moreover, for excitation efficiency of the QD film in the blue-light light-emitting diode, because the QD film merely has an excitation process with “one optical path”, lower light emitting efficiency is resulted in. Therefore, generally, a double brightness enhanced film (DBEF) film material also needs to be used, so that the blue light may be partially reflected between a reflector plate and the DBEF, and constantly excite the QD material, to obtain a design of high light emitting efficiency. However, this design manner requires the DBEF. Consequently, design costs of the display are dramatically increased, and this manner is not widely used.

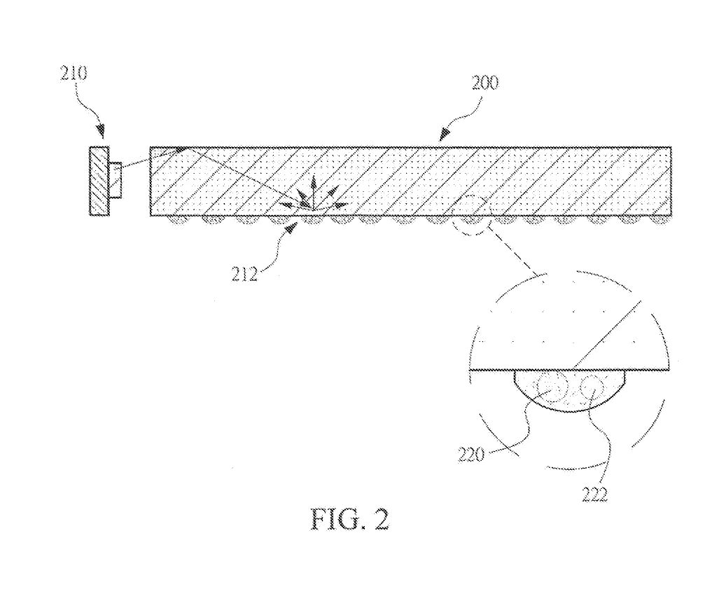

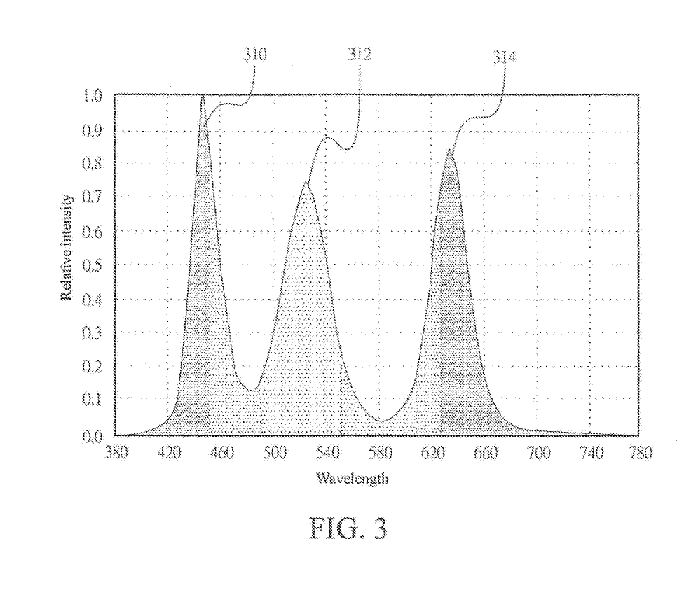

FIG. 2 is a schematic diagram of an optical design of a light guide plate using a QD material according to an embodiment of this application, and FIG. 3 is a spectrum display diagram of a white-light light source having red, green, and blue light with high color saturation and converted through excitation of a blue-light light source according to an embodiment of this application. Referring to FIG. 2 and FIG. 3, in an embodiment of this application, this application mainly provides an optical design manner using a QD material. The QD material is distributed at a side of a light guide plate 200. By using features of the light guide plate 200, a blue-light light-emitting diode light source 210 guided into the light guide plate (LGP) 200 is evenly converted into a surface light source from a blue-light light-emitting diode line light source through a particular distribution of screen dots 212 of the light guide plate 200, as shown in FIG. 2. It may be learned from FIG. 2 that the light source 210 is at the screen dots 212, and because the screen dots 212 damage a total reflection structure of the light guide plate 200, the light source 210 may be considered as a micro light source at the screen dots 212, converting the blue-light light source 210 of the light-emitting diode into a planar light source. At the screen dots 212 of the light guide plate 200, QD particle materials 220 of red light and green light are coated. That is, spectra (310, 312, and 314) of a white-light light source having red, green, and blue light with high color saturation are converted through excitation of the blue-light light source 210, as shown in FIG. 3. In addition, the coated QD material 220 is sealed at the screen dots 212 of the light guide plate 200 by using a separation glue 222 capable of isolating water vapor, to form the light guide plate 200 capable of having narrow red and green bands.

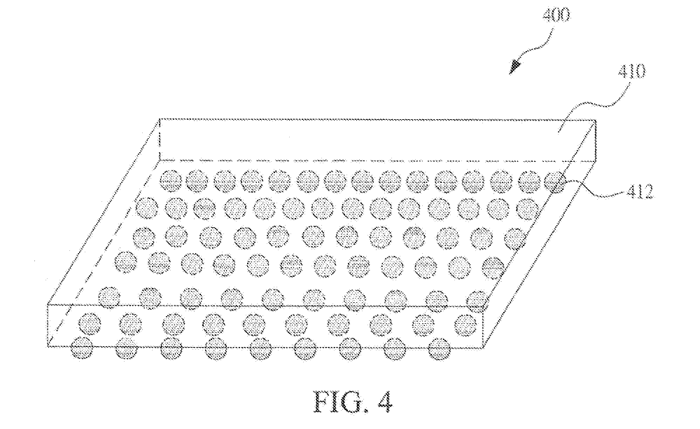

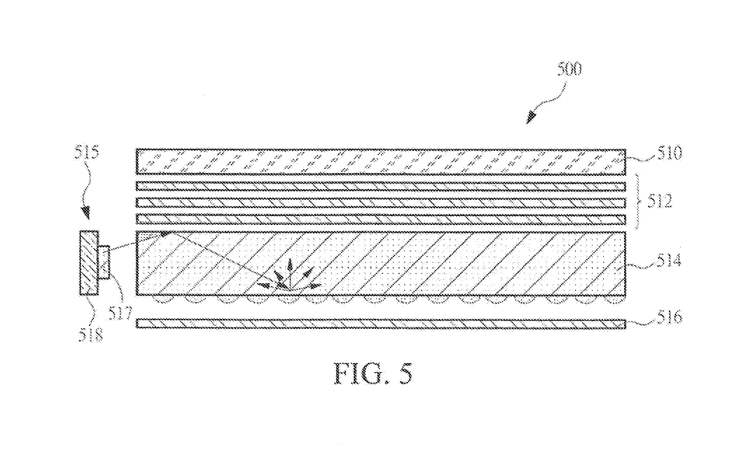

FIG. 4 is a schematic diagram of a design manner of printed screen dots according to an embodiment of this application, and FIG. 5 is an architectural diagram of a display having a light guide plate according to an embodiment of this application. Referring to FIG. 4 and FIG. 5, in an embodiment of this application, an excitation light source 515 required in this application may be usually a blue-light light-emitting diode having a relatively short band. Generally, blue light having a band in a range of 430 nm to 470 nm is used as the excitation light source 515. The excitation light source 515 is coupled to a light guide plate 514. A material of the light guide plate 514 may usually be selected from a PMMA or an MS series. The thickness of the light guide plate 514 may be set according to the size of an encapsulated light-emitting diode. Currently, a relatively common thickness is in a range of 0.5 mm to 3.0 mm, and different designs are made according to different display sizes. Generally, a television of a relatively large size may use a light guide plate of more than 2.0 mm. Subsequently, by using a selected bare board (not printed with screen dots) of the light guide plate and a mixture of yellow and green QD materials and a printing solvent, in screen dot manufacturing processes such as fabric card manufacturing, printing, and baking, designed positions of the screen dots are distributed at a side of the light guide plate. In this way, the light guide plate having a light emitting feature of the QD material is completed. The QD material is an III-V group or an II-VI group QD material. A material of the printing solvent may be ink or other materials capable of being screen-painted.

Referring to FIG. 2, FIG. 4, and FIG. 5, in an embodiment of this application, a method for manufacturing a light guide plate is provided. The light guide plate 514 has a mixture of the QD material 220 and the painting solvent. By means of screen dot manufacturing processes such as fabric card manufacturing, printing, and baking, designed positions of screen dots 412 are distributed at a side of the light guide plate 514. In this way, the light guide plate 514 having a light emitting feature of the QD material 220 is completed. The QD 220 is an III-V group or an II-VI group QD material 220. A material of the printing solvent may be ink or other materials capable of being screen-painted.

Referring to FIG. 4, in an embodiment of this application, printed screen dots 412 on the light guide plate 410 are in a distribution design of evenly distributing blue light injecting from side light as a planar light source in an optical simulation process.

Referring to FIG. 2, FIG. 4, and FIG. 5, in an embodiment of this application, a backlight module 400 includes: a light source 515, a light guide plate 514, a light emitting unit encapsulation member 518, and a QD sealing member 517. The light source 515 uses a blue light-emitting diode as an excitation light source. The light guide plate 514 includes a bottom surface 410 and a plurality of screen dots 412 arranged in a two-dimensional manner. These screen dots 412 are located on the bottom surface 410, each screen dot 412 includes a QD material 220, and the QD material 220 is screen-painted on the bottom surface 410 of the light guide plate 514. By means of a distribution of the screen dots 412 of the light guide plate 514, a line light source of the backlight module 400 is evenly converted into a surface light source. The light emitting unit encapsulation member 518 includes a light source substrate and a plurality of light emitting unit chips installed on the light source substrate. The QD sealing member 517 is disposed in a light emitting direction of the light emitting unit encapsulation member 518. The backlight module 400 is a light source. The screen dots 412 are in a density decreasing in a direction close to the light source, and the screen dots 412 are is a density increasing in a direction away from the light source. The QD material 220 has a yellow QD material and a green QD material. Each screen dot 412 further includes a separation glue 222, used for sealing the QD material 220.

Referring to FIG. 5, in an embodiment of this application, a display 500 having QDs includes: a light guide plate 514 exciting red and green light by using a blue-light light source 515 of a light-emitting diode and connected to an optical film 512 (for example, a reflector plate, a diffuser, or a prism film) and a reflector 516, and a display panel 510. A display having high color saturation may be designed.

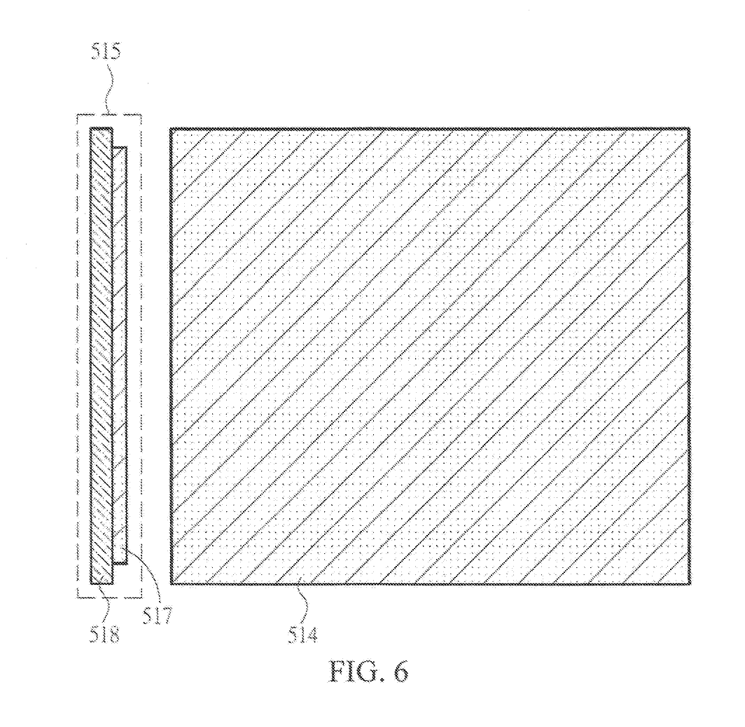

FIG. 6 is a schematic diagram of a light guide plate according to an embodiment of this application. Referring to FIG. 6, in an embodiment of this application, the QD sealing member 517 is directly engaged to the light emitting unit encapsulation member 518.

Referring to FIG. 6, in an embodiment of this application, the sealing member 517 is a stripe-shaped pipe or a flat-plate-shaped pipe.

In an embodiment of this application, the plurality of light emitting unit chips is aligned in a line or a plurality of lines.

In an embodiment of this application, the plurality of light emitting unit chips is arranged in a straight line, a curved line, or a predetermined pattern.

In an embodiment of this application, the QD includes a silicon-based nano crystal, a semiconductor nano crystal of an II-VI-group-based compound, a semiconductor nano crystal of an III-V-family-based compound, and any mixture thereof.

In an embodiment of this application, the plurality of light emitting unit chips is light-emitting diode chips.

In an embodiment of this application, the light source substrate is a printed circuit board, and the plurality of light emitting unit chips is directly installed on the light source substrate.

In an embodiment of this application, the light source substrate is a printed circuit board. Each or a plurality of light emitting unit chip encapsulation members is encapsulated into a chip encapsulation member, and the chip encapsulation member is installed on the light source substrate.

In an embodiment of this application, the plurality of light emitting unit chips is blue light-emitting diode chips, and the QDs of the blue light-emitting diode chips include: a first QD having a size allowing a band whose peak wavelength is in green light; and a second QD having a size allowing a band whose peak wavelength is in red light.

In an embodiment of this application, blue light excited by the light source has a wavelength in a range of 435 nanometers to 470 nanometers.

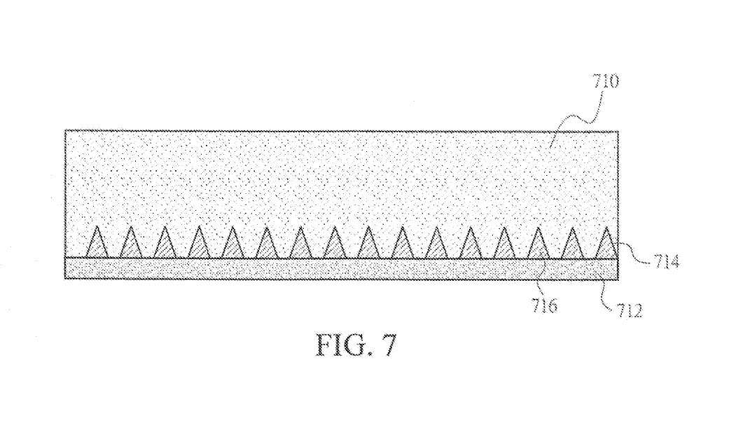

FIG. 7 is a schematic diagram of a light guide plate having a QD material according to an embodiment of this application. Referring to FIG. 7, in an embodiment of this application, a light guide plate 710 having a QD material includes a substrate 712 and a plurality of screen dot recessed parts 714 arranged in a two-dimensional manner. The screen dot recessed parts 714 are located on the substrate 712, and each screen dot recessed part 714 is filled with a QD material 716. By means of a distribution of the screen dot recessed parts 714 of the light guide plate 710, a line light source of the backlight module is evenly converted into a surface light source.

Specifically, the screen dot recessed part 714 is formed on a bottom surface of the light guide plate 710, and each screen dot recessed part 714 is filled with the QD material 716. The substrate 712 is disposed on the bottom surface of the light guide plate 710, and seals the QD material 716 in the screen dot recessed parts 714 of the light guide plate.

Specifically, as shown in FIG. 7, a method for manufacturing a backlight module of this application includes: providing a light guide plate 710, including a bottom surface and a plurality of screen dot recessed parts 714 arranged in a two-dimensional manner, where the screen dot recessed parts 714 are located on the bottom surface; filling a QD material 716 into each of the screen dot recessed parts 714; disposing a substrate 712 on the bottom surface of the light guide plate 710, and sealing the QD material 716 in the screen dot recessed parts 714 of the light guide plate 710 by using the substrate 712; and disposing a light source at one side of the light guide plate 710.

In some embodiments, when the substrate is disposed on the bottom surface of the light guide plate, the substrate 712 and the light guide plate 710 are engaged as an integral by illuminating, using laser, a seam between the substrate 712 and the light guide plate 710.

In some embodiments, the substrate 712 may include a reflective surface, to reflect light. The reflective surface may be made of a high reflectivity material, such as silver, aluminum, gold, chromium, copper, indium, iridium, nickel, platinum, rhenium, rhodium, tin, tantalum, tungsten, manganese, an alloy of any combination thereof, an anti-yellowing and heat-resistant white reflective paint, or any combination of the foregoing materials, to reflect light.

In some embodiments, a refractive index coefficient of the substrate 712 is less than or equal to a refractive index coefficient of the light guide plate, so as to form total reflection between the light guide plate 710 and the substrate 712, to reflect light.

In some embodiments, light excited by the light source has a wavelength in a range of, for example, 435 nanometers to 470 nanometers.

In some embodiments, the screen dot recessed parts 714 are disposed in a density decreasing in a direction towards the light source and are disposed in a density increasing in a direction away from the light source, so that backlight provided by the backlight module is more even.

In some embodiments, the QD material has, for example, a yellow QD material and a green QD material.

In some embodiments, each of the screen dot recessed parts 714 further includes a separation glue, used for sealing the QD material 716, to avoid water vapor.

The light source of this application may be, for example, a cold cathode fluorescent lamp (CCFL), a hot cathode fluorescent lamp (HCFL), a light-emitting diode (LED), an organic light emitting diode (OLED), a flat fluorescent lamp (FFL), an electro-luminescence (EL) component, a light bar, a laser light source, or any combination thereof.

The backlight module of this application may further include an optical film, for example, a diffuser, a prism sheet, a turning prism sheet, a brightness enhancement film (BEF), a dual brightness enhancement film (DBEF), a diffused reflective polarizer film (DRPF), or any combination thereof, and is disposed on the light guide plate, to improve an optical effect of light emission of the light guide plate.

An beneficial effect of this application is to introduce a QD material as an excitation light source without increasing extra component costs. Moreover, the QD material is repeatedly excited by using a total reflection principle of the light guide plate, thereby increasing conversion efficiency of red light and green light.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

The foregoing descriptions are merely preferred embodiments of this application, and are not intended to limit this application in any form. Although this application has been disclosed above through the preferred embodiments, the embodiments are not intended to limit this application. Any person skilled in the art can make some variations or modifications, which are equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A method for manufacturing a backlight module, comprising:
providing a light guide plate, comprising a bottom surface and a plurality of screen dot recessed parts arranged in a two-dimensional manner, wherein the screen dot recessed parts are located on the bottom surface;
filling a quantum dot material into each of the screen dot recessed parts;
disposing a substrate on the bottom surface of the light guide plate, and sealing the quantum dot material in the screen dot recessed part of the light guide plate by using the substrate; and
disposing a light source at one side of the light guide plate.

2. The method for manufacturing a backlight module according to claim 1, wherein when disposing the substrate on the bottom surface of the light guide plate, the substrate and the light guide plate are engaged as an integral by using a laser.

3. The method for manufacturing a backlight module according to claim 1, wherein an optical film is disposed on the light guide plate.

4. The method for manufacturing a backlight module according to claim 1, wherein the light guide plate has a mixture of the quantum dot material and a printing solvent.

5. The method for manufacturing a backlight module according to claim 4, wherein the quantum dot material is an III-V group quantum dot material.

6. The method for manufacturing a backlight module according to claim 4, wherein the quantum dot material is an II-VI group quantum dot material.

7. The method for manufacturing a backlight module according to claim 4, wherein a material of the printing solvent is ink.

8. The method for manufacturing a backlight module according to claim 1, wherein the substrate comprises a reflective surface.

9. The method for manufacturing a backlight module according to claim 8, wherein the reflective surface is made of a high reflectivity material.

10. The method for manufacturing a backlight module according to claim 1, wherein a refractive index coefficient of the substrate is less than a refractive index coefficient of the light guide plate.

11. The method for manufacturing a backlight module according to claim 1, wherein the refractive index coefficient of the substrate is equal to the refractive index coefficient of the light guide plate.

12. The method for manufacturing a backlight module according to claim 1, wherein light excited by the light source has a wavelength in a range of 435 nanometers to 470 nanometers.

13. The method for manufacturing a backlight module according to claim 1, wherein the screen dot recessed parts are disposed in a density decreasing in a direction towards the light source.

14. The method for manufacturing a backlight module according to claim 1, wherein the screen dot recessed parts are disposed in a density increasing in a direction away from the light source.

15. The method for manufacturing a backlight module according to claim 1, wherein the quantum dot material has a yellow quantum dot material and a green quantum dot material.

16. The method for manufacturing a backlight module according to claim 1, wherein each of the screen dot recessed parts further comprises a separation glue.

17. The method for manufacturing a backlight module according to claim 16, wherein the separation glue seals the quantum dot material.

18. A method for manufacturing a backlight module, comprising:
providing a light guide plate, comprising a bottom surface and a plurality of screen dot recessed parts arranged in a two-dimensional manner, wherein the screen dot recessed parts are located on the bottom surface;
filling a quantum dot material into each of the screen dot recessed parts, wherein the quantum dot material has a yellow quantum dot material and a green quantum dot material.
disposing a substrate on the bottom surface of the light guide plate, and sealing the quantum dot material in the screen dot recessed part of the light guide plate by using the substrate, wherein when disposing the substrate on the bottom surface of the light guide plate, the substrate and the light guide plate are engaged as an integral by using a laser, and a refractive index coefficient of the substrate is less than or equal to a refractive index coefficient of the light guide plate; and
disposing a light source at one side of the light guide plate, wherein light excited by the light source has a wavelength in a range of 435 nanometers to 470 nanometers;
wherein the screen dot recessed parts are disposed in a density decreasing in a direction towards the light source and the screen dot recessed parts are disposed in a density increasing in a direction away from the light source; and
each of the screen dot recessed parts further comprises a separation glue, used for sealing the quantum dot material.
